(19) United States
(12) Patent Application Publication
(10) Pub. No.: US 2026/0368303 A1
(43) Pub. Date: Nov. 19, 2026

(54) HARDWARE-BOUND DELEGATION OF GRADED TRUST AUTHORITY TO AUTONOMOUS SOFTWARE AGENTS

(71) Applicant: George William Bickerstaff, III, Greenwich, CT (US)

(72) Inventor: George William Bickerstaff, III, Greenwich, CT (US)

(21) Appl. No.: 19/738,410

(22) Filed: Jul. 11, 2026

(51) Int. Cl. G06F 21/44; G06F 21/64

(52) U.S. Cl. CPC G06F 21/44; G06F 21/64

(57) ABSTRACT

A hardware-bound infrastructure delegates trust authority from principals to autonomous software agents and subordinate agents. A secure element of the principal device signs a root delegation credential carrying a canonically encoded scope, quantitative bounds, a maximum depth, a signed transitivity-rule-table reference, and a revocation epoch. Child credentials derive within a trusted execution environment using a key-derivation function whose context binds the intersection of parent and requested scopes, so over-delegation corresponds to no derivable key. At verification time a transitivity engine computes each hop's effective authority deterministically from the signed rule table and an attested context vector of risk class, attestation freshness, and chain depth, emitting signed, reproducible determinations. Cascade revocation publishes epoch beacons over an epoch tree; relying nodes advance hardware monotonic counters and return signed acknowledgment receipts, making revocation propagation provable per node.

### CROSS-REFERENCE TO RELATED APPLICATIONS

This application is related in subject matter to a co-pending United States application by the same inventor directed to hardware-rooted agent identity registration and runtime attestation. No claim of priority or benefit under 35 U.S.C. 119, 120, or 121 is made to any application.

### STATEMENT REGARDING FEDERALLY SPONSORED RESEARCH OR DEVELOPMENT

Not Applicable.

### FIELD OF THE INVENTION

The present disclosure relates generally to computer security and authorization infrastructure, and more particularly to systems, methods, and non-transitory computer-readable media for delegating bounded authority from human or organizational principals to autonomous software agents and from agents to subordinate agents; for computing the effective authority of each delegation hop deterministically from signed transitivity rules and attested context; and for revoking delegated authority across arbitrarily deep delegation chains with provable, acknowledgment-receipted propagation.

### TECHNICAL PROBLEM AND SOLUTION

The technical problem is an authorization gap in agent delegation systems: delegated authority is carried in static tokens whose limits are enforced only by the policy of each verifying service, so nothing in the credential material itself prevents a subordinate from exceeding its parent's authority, nothing lets authority respond to the risk, staleness, or depth of the exercise, and nothing proves that a revocation reached any particular verifier. The technical solution is the combination described herein: the scope intersection of every sub-delegation is bound into the key-derivation context, so that a credential exceeding parent scope corresponds to no key that exists or can be created; a transitivity engine computes each hop's effective authority at exercise time from a signed, version-hashed rule table and a verification-time attested context vector, so that authority is graded, deterministic, and identically reproducible by any verifier; and cascade revocation over an epoch tree is anchored to hardware monotonic counters with per-node signed acknowledgment receipts, so that revocation propagation is provable and post-knowledge reliance is demonstrable. Each element of the solution is a change in what the computing system does—what keys can exist, what a verifier computes, what hardware attests—rather than a rule about what participants should do.

### BACKGROUND

Autonomous software agents increasingly receive authority from principals to act—to spend, contract, access data, and operate systems—and increasingly re-delegate portions of that authority to subordinate agents, subcontracted services, and tools. Delegation in deployed systems is expressed as scoped tokens or role assignments enforced by verification policy at each relying service. This arrangement fails in four technically identifiable ways as delegation chains deepen.

First, over-delegation is prevented only by policy, not by construction. A verification service that mis-evaluates containment, or a token service that issues over-broad scopes, produces a subordinate whose authority exceeds its parent's; nothing in the credential material itself makes such a subordinate impossible. Second, authority in existing systems is binary and static per credential: a delegate either holds a scope or does not, regardless of the task's risk, the delegate's attestation freshness, the depth of the chain, or the recency of the evidence supporting the delegation. Real principals intend authority to attenuate with depth, risk, and staleness, and today no machine-verifiable mechanism expresses that intent. Third, revocation across a delegation chain is unprovable: a principal who revokes a delegate's authority cannot establish which of the delegate's descendants ceased operating, when each relying service learned of the revocation, or which post-revocation exercises of authority occurred at services that provably knew better. Fourth, delegation across organizational boundaries requires each organization to trust the other's authorization policy wholesale, because there is no mechanism for translating one organization's scope semantics into another's under signed, auditable rules.

A technical mechanism is accordingly needed in which sub-delegation beyond parent scope is cryptographically impossible rather than procedurally forbidden; in which the effective authority of any hop is a deterministic, recomputable function of signed transitivity rules and attested context assembled at the moment of exercise; in which revocation propagates through the chain with per-node signed acknowledgments that make propagation latency and post-revocation noncompliance provable; and in which cross-organization delegation proceeds under signed policy-translation tables rather than wholesale trust.

### SUMMARY

By way of overview: autonomous agents today hold delegated authority as static tokens whose limits are enforced only by the policy of each verifying service, so over-delegation is merely forbidden rather than impossible, authority cannot respond to risk or staleness, and revocation cannot be proven to have reached anyone. The present disclosure makes delegated authority a hardware-anchored, computed quantity: sub-delegation beyond a parent's scope is cryptographically impossible, each hop's effective authority is recomputed at exercise time from signed rules and attested context, and revocation returns signed, counter-attested receipts from every relying node. The result is delegation that principals can bound in advance, verifiers can reproduce exactly, and auditors can reconstruct completely. No known arrangement—including pre-execution authorization-receipt logging and liveness-bound credential expiry—combines the three elements on which this disclosure rests: scope intersection bound into key derivation, effective authority computed per hop from signed tables and verification-time attested context, and a hardware-counter-anchored acknowledgment ledger that makes revocation propagation provable per node.

This disclosure describes a hardware-bound delegation infrastructure for trust authority. The inventive contribution resides in the ordered combination of six cooperating mechanisms, each recited with the specific hardware performing it. First, a root delegation credential issues from a secure element of the principal device, carrying a scope expression in a deterministic canonical encoding, quantitative bounds, a maximum delegation depth, a transitivity rule reference, an oversight predicate, and a revocation epoch reference. Second, each child delegation credential derives within a trusted execution environment using a key-derivation function whose context input includes a scope bound computed as the intersection of parent scope and requested scope, whereby a child credential exceeding its parent's scope corresponds to no derivable key. Third, a transitivity engine computes, at verification time and within a trusted execution environment, the effective authority of any delegation hop as a deterministic function of the parent's effective authority, a context vector comprising at least task risk class, attestation freshness of the delegate, chain depth, and evidence recency, evaluated under a signed, versioned transitivity rule table; authority thereby attenuates with depth, risk, and staleness by construction, and any verifier reproduces the same effective authority from the same inputs. Fourth, an oversight gate enforces, when a chain's oversight predicate fires, a hardware-authenticated human approval—including, in embodiments, a threshold set of approvals—before the delegated action executes. Fifth, cascade revocation proceeds by signed epoch beacons over an epoch tree: each relying node advances a hardware monotonic counter upon verified beacon receipt and returns a signed acknowledgment receipt, making the latest time by which each node knew of a revocation provable and rendering post-acknowledgment reliance on revoked authority demonstrably noncompliant. Sixth, cross-organization delegation proceeds through signed scope-translation tables applied deterministically within attested translation gateways.

Key technical effects. The described arrangement improves the functioning of the computing systems themselves, in at least the following measurable respects: (1) over-delegation is rendered cryptographically impossible—a child credential beyond parent scope corresponds to no derivable key, so the failure mode of a mis-configured verifier is eliminated rather than mitigated; (2) effective authority is deterministically reproducible by any verifier from the chain, the attested context, and the cited rule-table version hash; (3) trust decisions are hardware-enforced at every stage—issuance by a secure element, derivation within a trusted execution environment, revocation currency by a hardware monotonic counter that software cannot roll back; (4) revocation of an arbitrarily large delegation subtree requires a single constant-size beacon rather than per-credential messages, reducing message overhead, and chain-prefix caching amortizes validation cost across presentations; (5) revocation propagation time is provable per node—bounded by beacon intervals and acknowledgment deadlines expressed in signed material, with each node's knowledge fixed by its own signed receipt; (6) authority responds to runtime risk—the same chain carries less authority when attestation is stale, evidence is old, or the action's risk class is high, without any party exercising discretion; and (7) cryptographic assurance is upgradeable in place, per risk class, through algorithm agility including hybrid post-quantum signatures. Each effect is a change in how the computer performs authorization—in what keys can exist, in what a verifier computes, in what hardware attests—and not an automation of a human policy preference.

Additional embodiments provide exercise receipts recording each use of delegated authority; depth-limited derivation with hardware-decremented counters; degraded-mode authority reduction under beacon staleness; time-bound child credentials whose expiry is enforced by the same counter-and-beacon discipline; zero-knowledge proofs of correct effective-authority computation; and post-quantum signature agility. The scope-intersection key-derivation binding described herein is independently useful and may be practiced, and separately claimed, apart from the transitivity computation.

### BRIEF DESCRIPTION OF THE DRAWINGS

FIG. 1 is a block diagram of the delegation infrastructure.

FIG. 2 is a flow diagram of delegation issuance and derivation.

FIG. 3 is a schematic diagram of a delegation credential.

FIG. 4 is a flow diagram of effective-authority computation.

FIG. 5 is a flow diagram of acknowledgment-receipted cascade revocation.

FIG. 6 is a block diagram of cross-organization scope translation.

FIG. 7 is a schematic diagram of multi-hop authority attenuation.

FIG. 8 is a schematic diagram of epoch-tree subtree revocation.

### DETAILED DESCRIPTION

Reference will now be made to embodiments illustrated in the drawings. The embodiments are illustrative; features of different embodiments may be combined. Component names are used consistently throughout: the “principal device 102” belongs to the delegating human or organization; the “delegation authority service 110” maintains rule tables and epochs; the “agent computing device 120” hosts delegates and derives sub-delegations; the “relying party 130” verifies and computes effective authority; the “revocation service 140” publishes beacons and collects acknowledgments.

Definitions. As used herein: “Delegation credential” means a structured, cryptographically signed object conveying scope, bounds, depth limit, transitivity rule reference, oversight predicate, validity, and epoch reference for authority delegated to an identified delegate. “Scope expression” means a conjunction of clauses, each specifying an action class from a published taxonomy with optional counterparty constraints and quantitative bounds, in a deterministic canonical encoding such that containment and intersection are decidable identically by independent verifiers. “Transitivity rule table” means a signed, versioned table mapping context-vector components to attenuation coefficients and floors used in computing effective authority. “Effective authority” means the authority actually available to a delegation hop for a specific action at a specific time, as computed under the transitivity rule table; it is at most the credential's scope and typically less. “Context vector” means the tuple of attested inputs to that computation, assembled at verification time and comprising at least task risk class, delegate attestation freshness, chain depth, and evidence recency.

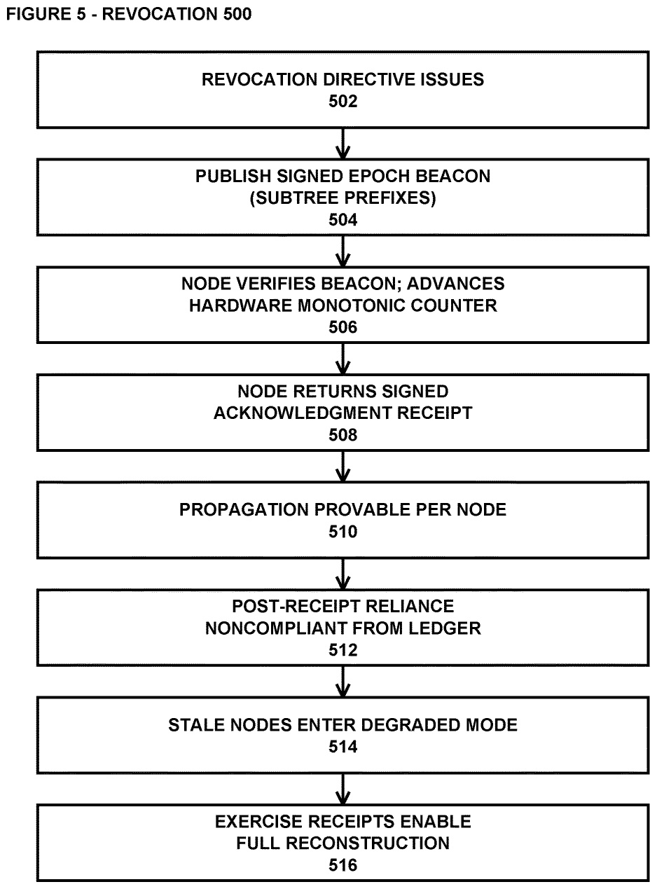

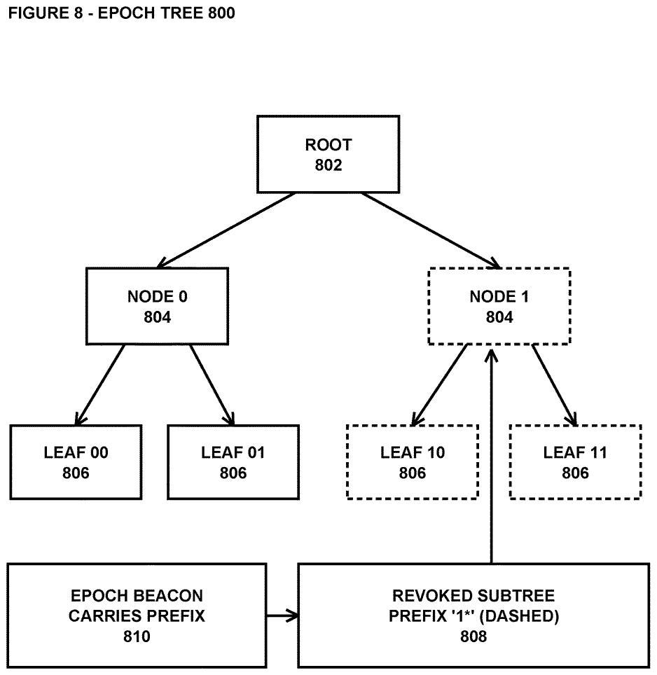

Definitions, continued. “Trust authority” means the bounded capacity of a delegate to perform actions that a relying party will honor, as conveyed by a delegation credential and quantified, per action, as effective authority. “Scope intersection” means the deterministic procedure of Algorithm 1, producing the largest scope contained in both of two scopes under the canonical encoding. “Hardware root of trust” means a hardware component—a secure element, trusted platform module, or hardware security module—whose private keys do not leave the hardware and from which the signatures of this disclosure chain. “Secure execution environment” and “trusted execution environment” are used interchangeably to mean an isolated execution context whose code identity and integrity are remotely attestable. “Attested,” applied to a value or input, means accompanied by a verifiable statement, signed under a key rooted in identified hardware, binding the value to the measurement or observation that produced it, such that a verifier can confirm the value's origin without trusting the presenting party. “Oversight predicate” means a machine-readable condition carried in a credential whose satisfaction requires a hardware-authenticated human approval before execution. “Epoch beacon” means a signed, digest-chained announcement published by a revocation service, carrying a new epoch and the identifiers of revoked epoch-tree subtrees. “Acknowledgment receipt” means a signed record returned by a relying node upon verified receipt of an epoch beacon, binding the node's identity, the beacon digest, and an attestation of the node's hardware monotonic counter state, and establishing the latest time by which that node knew of the revocation. Both are further described with reference to FIG. 5 and FIG. 8.

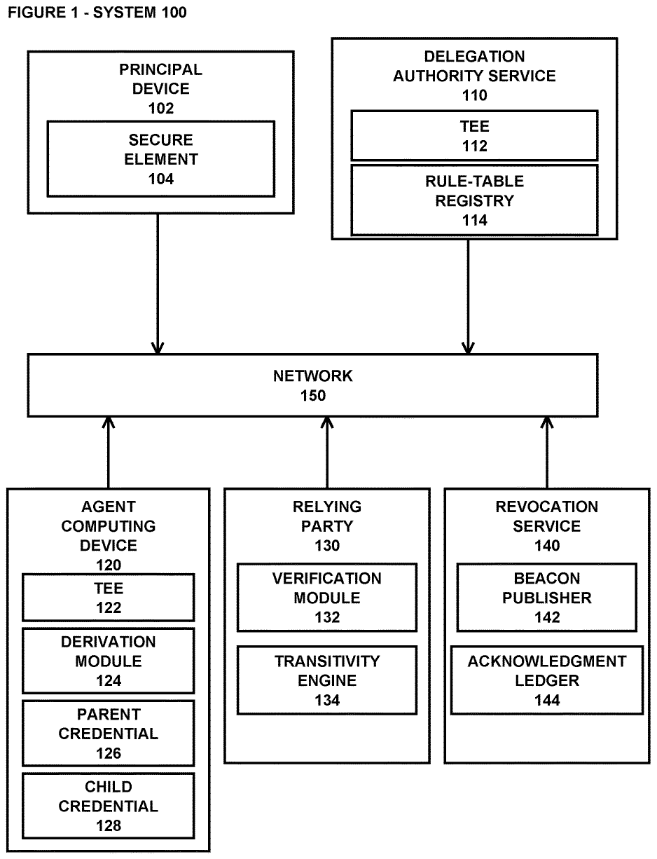

System architecture. FIG. 1 depicts a system 100 comprising a principal device 102 including a secure element 104; a delegation authority service 110 executing within a trusted execution environment (TEE) 112 and maintaining a rule-table registry 114; an agent computing device 120 including a trusted execution environment 122, a derivation module 124, a parent delegation credential 126, and one or more child delegation credentials 128; a relying party 130 including a verification module 132 and a transitivity engine 134; and a revocation service 140 including a beacon publisher 142 and an acknowledgment ledger 144; interconnected by a network 150.

The secure element 104 holds the principal's delegation signing key such that root credentials are signed only on the physical device in the principal's control; in embodiments the secure element 104 comprises a hardware security key, a secure enclave of a personal device, a trusted platform module conforming to the TPM 2.0 specification, or a hardware security module for organizational principals. The trusted execution environments 112 and 122 comprise, in embodiments, virtual-machine-isolation environments such as Intel Trust Domain Extensions or AMD SEV-SNP; realm-based environments under the Arm Confidential Compute Architecture; process-isolated enclave environments such as Intel Software Guard Extensions; system-partition environments such as Arm TrustZone; or confidential virtual machines offered by cloud computing providers, in which case attestation of the environment chains through the provider's attestation service to a hardware root of trust. The rule-table registry 114 stores transitivity rule tables signed by the delegation authority's hardware security module and versioned by content hash, so that any effective-authority determination can cite the exact table version under which it was computed. In embodiments a change from one rule-table version to another takes effect only at an epoch boundary announced by a signed epoch beacon, so that the version governing any determination is decidable from the presented chain's epoch reference and the beacon sequence, and no two verifiers can compute under different versions for the same epoch.

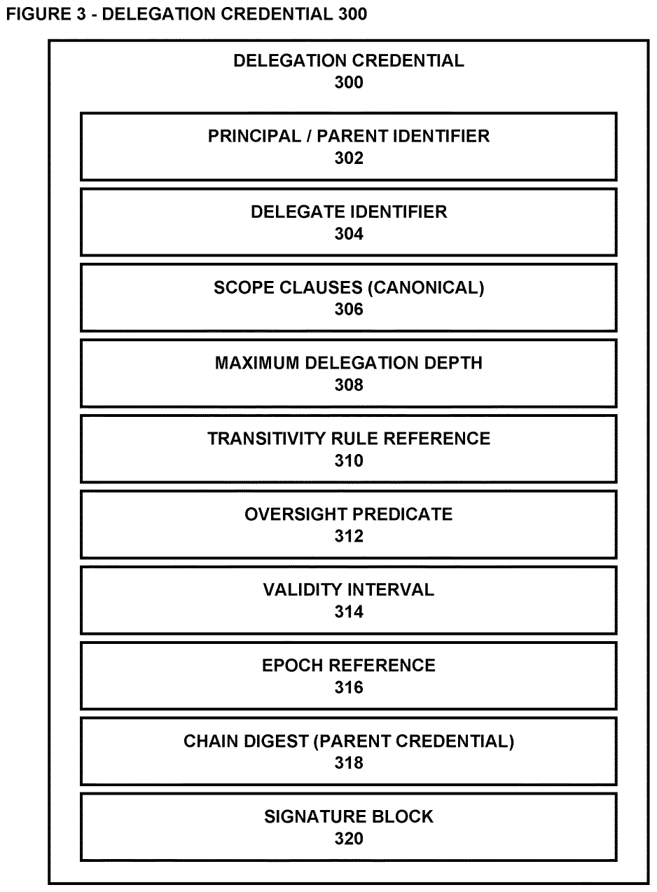

Delegation credential structure. FIG. 3 depicts a delegation credential 300 comprising: a principal or parent identifier field 302; a delegate identifier field 304; scope clauses 306 in the canonical encoding, each clause comprising an action class, optional counterparty constraints, and quantitative bound objects including per-action and cumulative limits over stated windows; a maximum delegation depth field 308, decremented at each derivation; a transitivity rule reference 310 identifying the governing rule table by version hash; an oversight predicate field 312; a validity interval field 314; an epoch reference field 316; a chain digest field 318 binding the credential to the digest of its parent credential such that chain order cannot be forged; and a signature block 320. The scope language deliberately excludes negation and recursion, so that containment of a requested action in a scope, and intersection of two scopes, are computed by a simple deterministic procedure with no discretion at any verifier.

Algorithm 1 (scope intersection). The intersection of a parent scope P and a requested scope R is computed as follows. Step 1: canonicalize P and R under the deterministic canonical encoding, sorting clauses by action-class identifier. Step 2: for each clause r in R, locate the set of clauses in P having the same action class; if the set is empty, strike r. Step 3: for each surviving r, conjoin the counterparty constraints of r with those of the matching parent clauses, and set each quantitative bound of r to the minimum of the requested bound and the corresponding parent bound. Step 4: discard any clause whose bound set is empty or whose constraint conjunction is unsatisfiable under the taxonomy's published constraint semantics. Step 5: emit the surviving clause set in canonical order as the intersection. Because the encoding admits neither negation nor recursion, every step is a total, deterministic operation over finite structures, and two independent verifiers executing Algorithm 1 over identical inputs necessarily produce identical results.

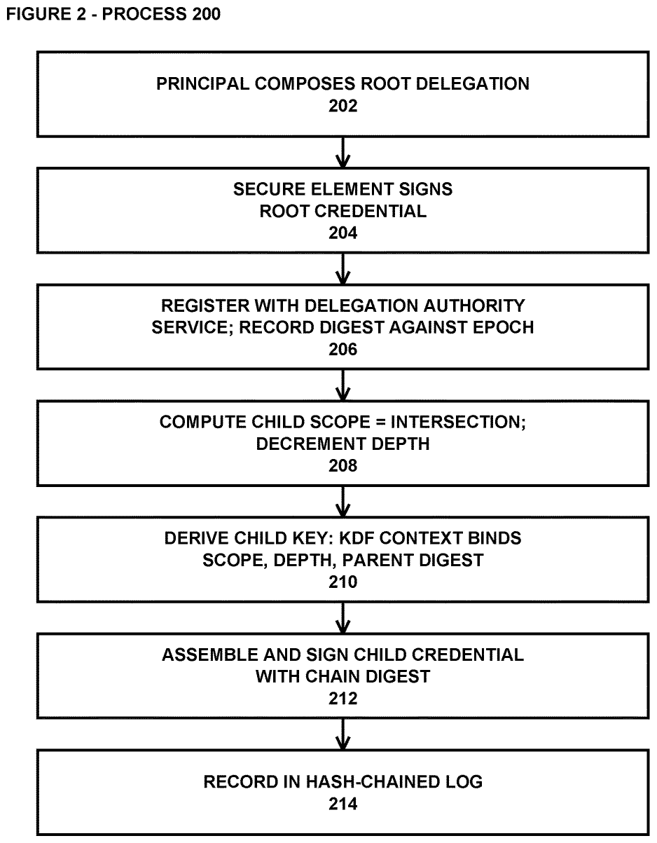

Issuance and derivation. FIG. 2 depicts a process 200. At 202, the principal composes a root delegation specifying scope, bounds, depth limit, rule reference, and oversight predicate. At 204, the secure element 104 signs the root delegation credential; the signing key never leaves the secure element. At 206, the credential is registered with the delegation authority service 110, which verifies well-formedness in-enclave and records the credential digest against the current epoch. At 208, upon a sub-delegation request, the derivation module 124, executing within the trusted execution environment 122, computes the child scope as the Algorithm 1 intersection of parent scope and requested scope and decrements the depth field, refusing derivation at zero. At 210, the child key is derived using a key-derivation function—HKDF instantiated with SHA-384 in the preferred implementation—whose context input includes the parent identity key, the computed child scope bound in canonical bytes, the decremented depth, and the parent credential digest; because the scope bound is bound into the derivation context, a purported child credential asserting any broader scope corresponds to no derivable key, and over-delegation is impossible by construction rather than forbidden by policy. At 212, the child credential 128 is assembled with the chain digest field 318 set to the parent credential digest, and signed under the derived key. At 214, the derivation event is recorded in an append-only, hash-chained delegation log whose chain heads are periodically countersigned by the delegation authority's hardware security module.

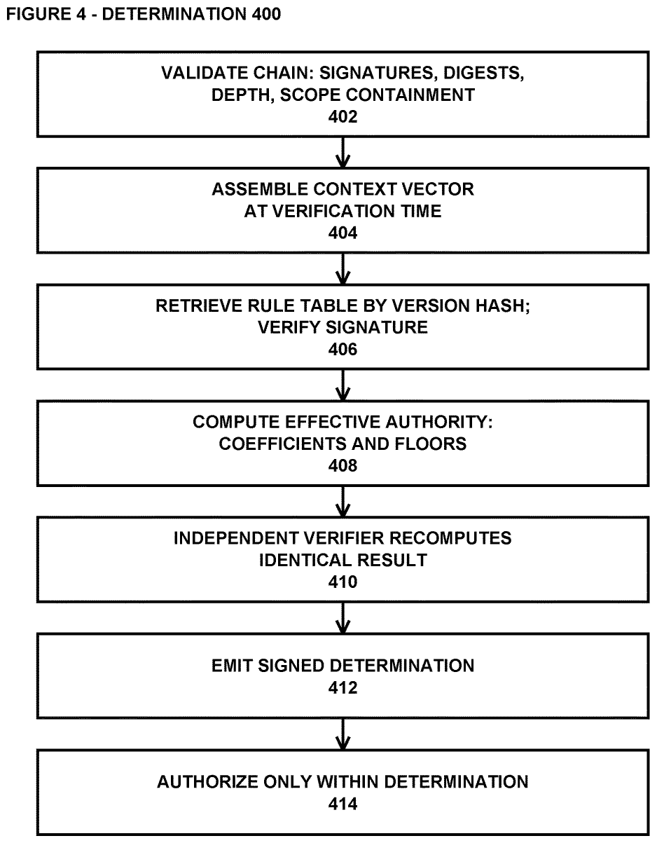

A structural distinction bears emphasis. Capability-token arrangements exist in which a holder appends restrictive caveats to a bearer token and cryptographic chaining prevents caveat removal, so that authority can only narrow along the chain. In such arrangements the narrowing is a set of verifier-evaluated predicates: the token names conditions, and a verifier decides at presentation whether each condition holds. The present arrangement differs in kind, in two respects. First, containment here is not a predicate evaluated by a verifier but a precondition of key existence: the child scope, computed by Algorithm 1, is an input to the key-derivation context at 210, so a credential asserting a scope outside the intersection is not a rejected credential but a credential for which no signing key exists anywhere. Second, the quantity delegated is not a set of surviving predicates but a graded numeric authority computed downstream, at verification time, by the transitivity engine under signed tables and attested runtime context, as described with reference to FIG. 4. A caveat chain fixes at delegation time everything a verifier will later check; the present arrangement leaves effective authority to be computed at exercise time from conditions—attestation freshness, evidence recency—that cannot be known at delegation time. The computation, moreover, modifies nothing: no caveat or restriction is appended to any credential of the presented chain, each credential remaining unmodified from its derivation through the emission of the effective-authority determination.

A related distinction applies to arrangements in which quantitative dimensions of authority—a spending amount, a depth allowance, a lifetime—narrow monotonically along a delegation chain by the delegating party's choice at each hop. Such narrowing, however graded its dimensions, fixes each hop's authority at delegation time as a position selected by the delegator. In the present arrangement no party selects the effective authority: the verifier executes a coefficient lookup, keyed to attested values observed at verification time, under a table neither the delegator nor the delegate controls, so that the same chain carries different effective authority as attestation freshness and evidence recency change, and no delegation-time selection can fix it.

Chain validation. FIG. 4 depicts the transitivity engine's determination 400, executed within an attested environment of the relying party 130 (or, in service embodiments, of the delegation authority service 110). At 402, the verification module 132 validates the credential chain: each link's signature, each chain digest 318 against the presented parent, each depth decrement, and each scope containment by re-executing Algorithm 1. A chain failing any check is rejected before any authority computation occurs.

Context vector. At 404, the context vector is assembled at verification time from attested inputs only: the requested action's risk class from a published classification; the delegate's attestation freshness, taken as elapsed time since the delegate's last verified attestation; the chain depth of the presenting hop; and evidence recency, taken as the age of the youngest evidence supporting the root delegation. In embodiments the context vector further comprises optional attested components, each usable as a rule-table input: a model integrity or provenance hash of the presenting delegate's underlying model, permitting the table to attenuate authority for delegates whose model provenance is unverified or superseded; a tool schema integrity digest, permitting attenuation when the tool surface available to the delegate has changed since delegation; environmental risk signals, such as an attested network posture or jurisdiction indicator; and a behavioral reputation score issued by a designated scoring authority and carried as a signed assertion. Each optional component enters the computation only through the signed rule table, preserving determinism: a verifier lacking an optional component applies the table's designated default coefficient for its absence.

Algorithm 2 (effective authority). At 406, the governing transitivity rule table is retrieved by the version hash cited in field 310 and its signature verified. At 408, effective authority is computed as follows. Step 1: initialize each quantitative bound to the root credential's granted bound. Step 2: for each hop k from 1 to the presenting depth, multiply each bound by the table's depth coefficient for hop k. Step 3: for each context component in the assembled vector, look up the table's coefficient for that component's attested value or value range, and multiply each bound by that coefficient. Step 4: for each action class, compare each resulting bound to the table's floor for that class; a bound at or below the floor is set to zero, and a scope clause all of whose bounds are zero is treated as absent. Step 5: emit the resulting bound set as the effective authority of the presenting hop. Every input to Steps 1 through 5 is signed or attested and every operation is deterministic under the version-hashed table, so at 410 any second verifier recomputes the identical effective authority. At 412 the transitivity engine 134 emits a signed effective-authority determination binding the credential chain digest, context vector, table version, and computed bounds. At 414, the requested action is authorized only if it falls within the determination, and the determination is recorded with the authorization.

By way of a first illustrative example: a root delegation grants a purchasing scope of $10,000 per transaction; the table specifies a depth coefficient of 0.5 per hop, a coefficient of 0.5 for attestation staleness beyond one hour, and a floor of $100. A second-hop delegate with fresh attestation holds $2,500 effective authority; the same delegate with stale attestation holds $1,250; a fourth-hop delegate with stale attestation holds the $312.50 computation, and a fifth hop the floor. The values are policy parameters; the mechanism is that the attenuation is computed, signed, and reproducible, rather than being a static grant or an unverifiable server-side judgment.

A second illustrative example traces a complete four-hop purchasing chain under one table, showing per-hop context and computed authority. The root grants $10,000 per transaction, risk class “procurement,” depth limit 5, and the table specifies a depth coefficient of 0.5 per hop, a staleness coefficient of 0.5 beyond one hour, a risk-class coefficient of 1.0 for procurement and 0.25 for “financial-transfer,” and a $100 floor. Hop 1, a planning agent attested twelve minutes ago requesting a procurement action: bound=10,000×0.5=$5,000. Hop 2, a sourcing agent attested twenty minutes ago, procurement: 10,000×0.5×0.5=$2,500. Hop 3, a purchasing agent whose attestation is ninety minutes old, procurement: 10,000×0.5×0.5×0.5 (depth)×0.5 (staleness)=$625. Hop 4, the same purchasing agent requesting a financial-transfer action while stale: 10,000×0.0625 (depth)×0.5 (staleness)×0.25 (risk class)=$78.13, which is below the $100 floor and is therefore zero: the action is refused outright. Every figure in this table is recomputable by any verifier from the chain, the attested context, and the cited table version.

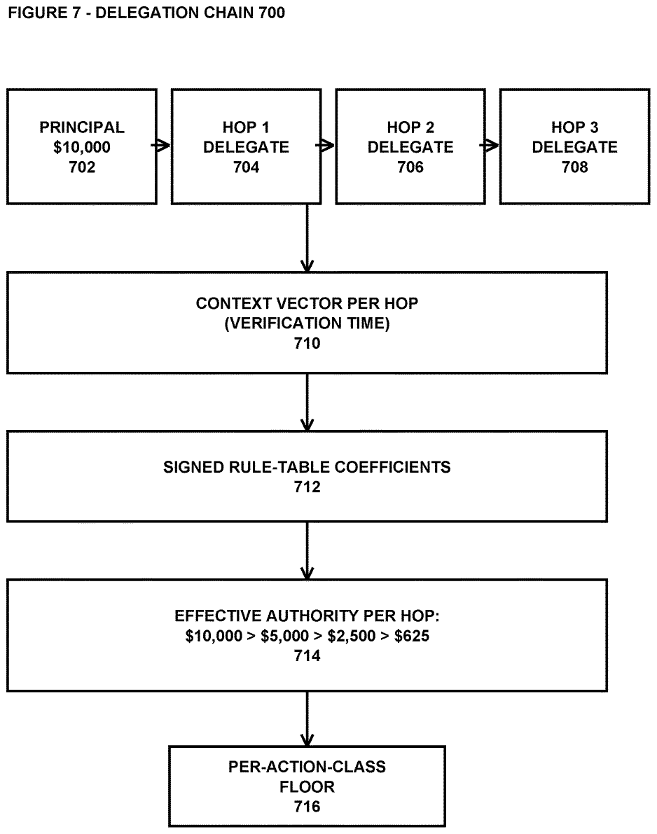

FIG. 7 depicts this operation as a delegation chain 700: a principal 702 with the root bound, and delegates at successive hops 704, 706, and 708. Context vectors 710 are assembled per hop at verification time; attenuation coefficients 712 are drawn from the signed, version-hashed rule table; and the resulting effective-authority values 714 decline along the chain until they meet the per-action-class floor 716. The figure makes visible the property that the same delegate at the same hop holds different effective authority under different attested context, and that no party—not the delegate, not the relying party—exercises discretion in the computation.

Oversight gate. When the oversight predicate 312 of any credential in the chain is satisfied by the requested action—for example, an action exceeding a stated value, an action in a designated class, or any action at depth beyond a stated bound—the relying party 130 suspends authorization pending a human approval authenticated by a hardware authenticator registered to the principal or a designated overseer, and binds the approval signature into the authorization record. In threshold embodiments the oversight predicate designates an overseer set and a threshold t, and authorization proceeds only upon t distinct approvals from n registered hardware authenticators of the set, the full approval set being bound into the authorization record so that the identity of every approving overseer is auditable. The oversight gate converts human-in-the-loop policy into a per-action, hardware-authenticated, machine-verifiable condition.

Revocation. FIG. 5 depicts acknowledgment-receipted cascade revocation 500. At 502, a revocation directive issues from the principal via the secure element 104, from the delegation authority service 110, or from a parent delegate for its subtree. At 504, the beacon publisher 142 publishes a signed epoch beacon carrying the new epoch, the revoked chain-node identifiers expressed as subtree prefixes over the epoch tree, a timestamp, and the digest of the prior beacon. At 506, each relying node verifies the beacon and advances a hardware monotonic counter to the new epoch; the counter cannot be rolled back by software. At 508, the relying node returns a signed acknowledgment receipt binding its node identity, the beacon digest, and its counter attestation; the revocation service 140 records receipts in the acknowledgment ledger 144, which is append-only and hash-chained, its heads periodically countersigned by a hardware security module, so that omission or reordering of a recorded receipt is detectable from the ledger structure. At 510, propagation is thereby provable per node: the receipt establishes the latest time by which that node knew, and at 512 any authorization by that node of a superseded credential after its receipt timestamp is demonstrably noncompliant from the ledger alone. At 514, nodes whose latest acknowledged beacon exceeds a configured age enter degraded mode. At 516, exercise receipts—signed records emitted at each authorized use of delegated authority, binding chain digest, effective-authority determination, and action digest—permit complete post-hoc reconstruction of every exercise of any delegation, before and after any revocation.

Epoch tree. FIG. 8 depicts an epoch tree 800 formalizing subtree revocation. The tree comprises a root node 802, interior nodes 804, and leaf epochs 806; every delegation credential's epoch reference field 316 locates the credential under exactly one leaf, and every node is addressed by the bit-prefix of the path from the root, so that a subtree is identified by a constant-size prefix regardless of the number of credentials beneath it. A revoked subtree identifier 808—for example the prefix “1*”—supersedes every credential under interior node 804 addressed by that prefix (the superseded node and leaves being depicted with dashed borders in FIG. 8), and is carried in an epoch beacon 810 without enumerating descendants. Prefix semantics resolve overlapping and nested revocations deterministically: a beacon revoking a prefix and a later beacon revoking a longer prefix within it are cumulative; a beacon revoking a shorter prefix subsumes all longer prefixes beneath it; and reinstatement is never expressed by prefix withdrawal but only by issuance of new credentials under a fresh leaf, so that the revoked set is monotone within an epoch lineage and no verifier can be induced to un-revoke by beacon reordering.

Algorithm 3 (revocation acknowledgment protocol). Step 1: the relying node receives a candidate beacon and verifies the publisher signature and the digest link to the node's last accepted beacon; a beacon failing either check is discarded without counter movement. Step 2: the node compares the beacon epoch to its hardware monotonic counter; a beacon at or below the counter is a replay and is discarded. Step 3: the node advances the counter to the beacon epoch; the advance is performed by the hardware and is irreversible. Step 4: the node constructs an acknowledgment receipt binding its node identity, the beacon digest, and a hardware attestation of the post-advance counter state, signs it, and transmits it to the revocation service 140. Step 5: the revocation service verifies the receipt signature and counter attestation and appends the receipt to the acknowledgment ledger 144. Step 6: if a configured acknowledgment deadline passes without a receipt from a registered node, the revocation service records the lapse, and downstream verifiers treating that node's authorizations apply the degraded-mode discipline described below. The protocol yields, for every registered node, either a signed receipt establishing when the node knew, or a recorded lapse establishing that it failed to acknowledge—there is no silent third state.

Revocation service levels. In embodiments, quantitative revocation service levels are expressed in credentials or rule tables as machine-verifiable parameters rather than as contractual prose: a maximum beacon-to-acknowledgment latency per node class; a maximum beacon publication interval, so that silence itself is bounded; and degraded-mode trigger thresholds stating the acknowledged-beacon age beyond which a node must reduce authority. Because the parameters are carried in signed material and the acknowledgment ledger 144 timestamps every receipt, conformance to each service level is decidable from the ledger, and an operator's failure to meet a latency bound is itself provable.

A further structural distinction bears emphasis. Cascade invalidation—the rule that revoking a node invalidates its descendants—exists in credential systems and directory services, and epoch or freshness disciplines exist in which verifiers reject material older than a staleness window. Both leave the central forensic question unanswerable: which relying service knew of the revocation, and by when. The present arrangement answers it structurally. The signed acknowledgment receipt of Algorithm 3, bound to a hardware counter attestation, converts propagation from an assumption into a per-node record; the ledger of receipts makes the propagation frontier itself an auditable object; and the combination of receipt timestamp with the node's own authorization records makes post-knowledge reliance on revoked authority demonstrable without access to the node's internal state. Invalidation says what should no longer be honored; the receipt discipline proves who knew, and when, that it should not be.

Two further structural distinctions bear emphasis. Arrangements exist in which a principal signs an authorization record before an agent acts—binding scope boundaries, a time window, and a commitment to the agent's model state—and publishes that record to an append-only log as a precondition of execution. Such a record is an authorization receipt: it proves what was authorized, once, at the head of a single delegation. It computes no authority for any subsequent hop, narrows nothing by key derivation, and says nothing about revocation; the receipts of the present arrangement are the converse instrument, issued by relying nodes upon revocation and proving what each node knew and when. Separately, arrangements exist in which a credential's validity is bound to periodic liveness proofs of its issuer, so that cessation of the proofs causes descendant credentials to expire within a clock-bounded window without any network round-trip. Such liveness-bound expiry is implicit revocation: it bounds how long a revoked subtree can act, under clock-skew assumptions, but produces no record of which verifier learned what and when, and grades nothing. The present arrangement's beacons, counters, and receipts make revocation explicit, ordered, and evidentiary, and operate alongside—not in place of—the epoch-relative expiry of derived credentials described above.

Two final structural distinctions complete the record. Arrangements exist in which session keys derive from a shared secret through cascaded invocations of a derivation function, each invocation appending a restricting parameter chosen by the deriving party, so that each derived key carries a smaller scope of permissible use and an authenticator verifies by recomputing the cascade. Such parameter-cascade derivation narrows by delegator-appended restriction over an ad hoc parameter vocabulary. The present derivation differs in what is bound and what follows from the binding: the context input is the computed intersection—the Algorithm 1 output over the parent scope and a requested scope, both expressed in a canonical language with decidable containment—together with the decremented depth and the parent credential digest, so containment is not a property the verifier checks by recomputing appended restrictions but a precondition of the key's existence relative to any asserted scope; and the derived credential's authority is not the bound scope but a quantity computed downstream, at exercise time, by the transitivity engine. Separately, arrangements exist in which a confidence score attached to an identity attribute deteriorates over time and gates access when it falls below a threshold. Such decay adjusts confidence in an attribute for a binary access decision; it computes no delegated authority, follows no chain, cites no versioned table, and emits nothing a second verifier can recompute. In the present arrangement staleness is one attested component among several, entering a deterministic, table-governed computation of graded authority whose result is signed and reproducible.

Degraded mode and partition recovery. A relying node whose most recently acknowledged beacon exceeds the configured age applies a degraded-mode reduction: the table designates degraded-mode coefficients, typically severe, applied to all chains until a current beacon is acknowledged; in embodiments designated high-risk action classes are suspended entirely during degradation. Upon partition healing, the node resynchronizes by fetching the beacon sequence forward from its counter state, verifying each digest link, advancing the counter once to the newest epoch, and emitting a single acknowledgment receipt for the newest beacon together with a resynchronization record enumerating the beacon digests traversed. Exercise receipts emitted during a degraded period carry a degraded-mode flag, so that an auditor can isolate every exercise of authority that occurred while the node's revocation view was stale and subject those exercises to heightened review.

Time-bound child credentials. In embodiments each child credential carries a relative expiry bound to its parent: a validity interval 314 no later than the parent's, and, additionally, an epoch-relative lifetime stating the number of epochs the credential survives beyond the epoch of its derivation. Because every relying node tracks the current epoch in a hardware monotonic counter, epoch-relative expiry is enforced by the same counter-and-beacon discipline as revocation, requiring no synchronized clocks: a credential whose derivation epoch plus lifetime is below the counter is expired wherever it is presented, and expiry cannot be evaded by presenting to a node with a slow clock.

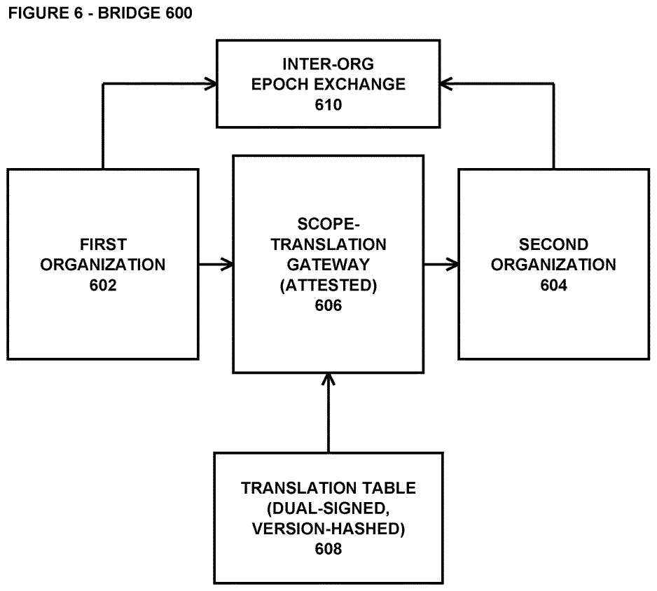

Cross-organization delegation. FIG. 6 depicts a bridge 600 between a first organization 602 and a second organization 604. A scope-translation gateway 606 executes within an attested environment and applies a translation table 608, signed by both organizations and versioned by hash, mapping action classes and bound semantics of the first organization's taxonomy into the second's. A credential presented across the boundary is translated deterministically at 606; the translated credential carries the translation-table version and the original credential digest, so the translation is recomputable; and untranslatable clauses are struck rather than approximated. An inter-organization epoch exchange 610 carries each organization's beacons to the other's relying nodes under the same monotonic-counter and acknowledgment-receipt discipline, extending provable revocation across the boundary.

Algorithm 4 (scope translation). Step 1: verify the dual signatures and version hash of the translation table 608. Step 2: canonicalize the presented credential's scope clauses. Step 3: for each clause, look up the action-class mapping in the table; if no mapping exists, strike the clause and append its identifier to a signed exception list accompanying the translated credential. Step 4: for each mapped clause, translate counterparty constraints and quantitative bound semantics—including unit and window conversions stated in the table—deterministically; a constraint the table cannot express is likewise struck to the exception list, never approximated. Step 5: emit the translated credential binding the translation-table version, the original credential digest, and the exception list. The exception list is itself signed by the gateway's attested environment, so the receiving organization can see precisely what authority was lost in translation, and best-effort partial translation is distinguishable, by construction, from complete translation. Explicit failure modes are defined: a table signature failure, a version-hash mismatch, or an empty surviving clause set each yields a translation refusal, never a permissive default.

Protocol integration embodiments. In tool-invocation embodiments, delegation credentials and effective-authority determinations are carried in the metadata of tool-call messages of an agent tool protocol: the presenting agent attaches its credential chain to the tool call, the tool server acts as relying party 130, executes the determination 400, and returns the signed determination alongside the tool result, so that the tool invocation itself is bounded by computed authority. An illustrative message binding carries fields for the chain of credential digests, the canonical scope bytes of the presenting hop, the assembled context vector, the rule-table version hash, and the determination signature. In inter-agent embodiments, the same fields are carried in the message envelope of an agent-to-agent protocol, and the receiving agent's runtime performs chain validation at 402 before accepting any delegated task, so that a task message asserting authority its sender's chain cannot support is rejected at the envelope, before task content is processed. In both embodiments verification proceeds identically because every input is carried or resolvable by hash; the transport contributes nothing to the trust computation.

Security analysis. The threat model comprises at least: (a) over-delegation, an adversary holding a legitimate credential attempting to mint a child with broader scope; (b) forgery, an adversary without key material attempting to fabricate a credential or determination; (c) replay, an adversary re-presenting superseded credentials, beacons, or determinations; and (d) collusion, a delegate and a relying party jointly attempting to honor authority that the chain does not support or that revocation has withdrawn.

The defenses are as follows. Against (a): the child key exists only as the key-derivation output over a context containing the Algorithm 1 intersection; a broader asserted scope changes the context bytes and therefore addresses a key that was never derived and cannot be derived without the parent secret, so the attempt fails at signature verification everywhere, independent of any verifier's policy. Against (b): every credential, table, beacon, receipt, and determination is signed under keys rooted in the secure element 104 or attested environments; fabrication reduces to signature forgery on the underlying scheme. The hardware trust assumption is stated explicitly: secure elements and trusted execution environments are assumed tamper-resistant within their certification envelopes, and a compromise of such hardware is treated as a compromise of the keys it holds—detectable thereafter through attestation-freshness decay, which attenuates the compromised delegate's effective authority under the rule table, and terminable through the epoch discipline like any other revocation. Against (c): beacons carry epochs checked against hardware monotonic counters that software cannot roll back, and determinations bind the context vector and table version, so a replayed determination is detectable by any auditor recomputing under current context. Against (d): a colluding relying party that authorizes beyond computed authority produces an authorization record inconsistent with the recomputable determination, and one that honors revoked authority after acknowledgment produces a record postdating its own signed receipt; in both cases the ledger and receipts make the collusion demonstrable by third parties without the cooperation of either colluder.

The over-delegation property admits a reduction argument. Suppose an adversary, given a parent credential and its public material but not the parent secret, produces a verifying child credential whose scope is not contained in the parent's. Verification requires a signature under the child key; the child key is defined as the key-derivation output over a context that includes the canonical bytes of the Algorithm 1 intersection; a non-contained scope yields context bytes differing from every context for which derivation was performed. The adversary has therefore either evaluated the key-derivation function without the parent secret—contradicting the pseudorandomness of the underlying function—or forged a signature under a key it does not hold—contradicting the unforgeability of the signature scheme. Over-delegation is thus foreclosed by the security of the primitives, not by the vigilance of verifiers.

Zero-knowledge embodiments. In embodiments the transitivity engine 134 emits, together with or in place of the plain determination, a zero-knowledge proof that the effective authority was computed correctly under the cited table version from a context vector satisfying stated predicates, without revealing the context vector or the table contents. A relying party or downstream auditor verifies the proof against the table's version hash and the chain digest. Such embodiments serve deployments in which the context vector itself is sensitive—for example, where attestation cadence or behavioral scores are proprietary—while preserving the property that the computation is verifiably correct.

Post-quantum embodiments. Signatures of the secure element 104, the delegation authority's hardware security module, and derived credential keys employ, in embodiments, a lattice-based scheme such as ML-DSA; in hybrid embodiments each signature block 320 carries both a classical signature and a lattice-based signature over the same content, and a verifier accepts only if both verify, so that the arrangement is secure while either assumption holds. An algorithm-agility field of the credential permits rule tables to mandate post-quantum or hybrid signatures per risk class, so that designated classes—payments above a threshold, for example—require post-quantum protection while lower classes migrate on an operator's schedule. A migration path is thereby defined in signed material: an operator raises the mandated classes table-version by table-version, and every determination cites the version under which it was computed, so the protection level of any historical authorization is auditable.

Audit format. In embodiments exercise receipts and effective-authority determinations are serialized in a canonical machine-readable schema suitable for ingestion by security-information and forensic systems: a JSON object with deterministic member ordering comprising, for a determination, members for the chain digest, the context vector with named components, the rule-table version hash, the computed bounds per action class, the degraded-mode flag, and the determination signature; and, for an exercise receipt, members for the determination digest, the action digest, the relying-node identity, the epoch at exercise, and the receipt signature. Canonical serialization ensures that a digest over the record is reproducible, so audit records chain and cross-reference by hash exactly as credentials do.

Reference implementation guidance. An implementation exposes at least three interfaces. The derivation module 124 exposes a derive interface accepting a parent credential, a requested scope, and a delegate identity, and returning a child credential or a refusal, with the Algorithm 1 intersection and depth decrement performed inside the trusted execution environment 122 and the key derivation never exporting key material. The transitivity engine 134 exposes a determine interface accepting a credential chain, a requested action, and attested context sources, and returning the signed determination of FIG. 4. An acknowledgment handler of the relying node exposes a beacon interface accepting candidate beacons and executing Algorithm 3, and a status interface reporting the node's counter state and last-acknowledged beacon digest for audit. Each interface is specified by its inputs, outputs, and refusal conditions, so that independent implementations interoperate at the credential and receipt formats without sharing code.

Payment and regulated embodiments. In payment embodiments the relying party 130 comprises a payment network node, and an agent-initiated payment clears only within the computed effective authority of the presenting hop, so that the graded attenuation of FIG. 7 operates as a per-transaction, per-hop spending control enforced at the network rather than at the agent. In regulated embodiments the signed determination and exercise receipt are bound into the institution's transaction reporting records, so that for any reportable transaction the institution can produce the exact computed authority under which the transaction cleared, the context under which it was computed, and the table version then in force; supervision of agent-initiated activity thereby acquires the same recomputability as the authorization itself. Analogous embodiments apply to brokerage order flow, healthcare data release under delegated consent, and government benefit disbursement, in each case with the action-class taxonomy and floors set by the regulated operator's tables.

Further deployment embodiments. In enterprise embodiments, employees delegate bounded authority to productivity and workflow agents under organizational rule tables, so that agent authority attenuates uniformly across the enterprise and every exercise is reconstructible from the audit schema. In healthcare embodiments, a clinician delegates record-access and documentation authority to a clinical agent, with oversight predicates requiring hardware-authenticated approval for any release beyond the treating relationship and evidence recency tied to the currency of the underlying consent. In government embodiments, caseworker agents disburse benefits under rule tables whose floors and ceilings encode statutory limits, with the canonical audit format serving oversight bodies directly. In robotics and embodied-agent embodiments, action classes designate physical operations—actuation classes, navigation zones, manipulation of designated object categories—with risk-class coefficients reflecting physical hazard and the transitivity engine executing within the trusted execution environment of the onboard controller. In multi-agent embodiments, an orchestrating agent decomposes a task across specialist sub-agents, each sub-delegation deriving under Algorithm 1 and attenuating under Algorithm 2, so that the leaf agent performing the most exposed action holds the least authority, by construction rather than by convention.

In batch embodiments, a device hosting many delegates amortizes chain validation by caching validated chain prefixes keyed to epoch and invalidating the cache on beacon receipt. In offline embodiments, a relying node validates against its last-acknowledged epoch and applies degraded-mode authority, so connectivity loss reduces rather than eliminates verification. In distributed-ledger embodiments, the beacon publisher 142 additionally anchors each beacon digest, and the acknowledgment ledger 144 its periodic chain heads, to a distributed ledger, so that beacon publication times and receipt recording times are independently verifiable without trusting the revocation service.

Advantages over conventional arrangements. Relative to scoped-token authorization, over-delegation is impossible by key derivation rather than discouraged by verifier policy, and authority is graded by attested context rather than binary. Relative to role- and policy-based delegation hierarchies, the effective authority of any hop is a signed, reproducible computation citing a version-hashed rule table, not a server-side judgment; two verifiers cannot disagree. Relative to revocation lists and short-lived credentials, revocation carries per-node acknowledgment receipts that make propagation latency and post-revocation noncompliance provable from a ledger. Relative to federated authorization arrangements, cross-organization delegation proceeds under signed translation tables with recomputable results and signed exception lists rather than wholesale acceptance of a counterpart's policy engine. Each advantage is a property of the recited mechanisms—the derivation context binding of Algorithm 1's output, the deterministic attenuation of Algorithm 2 under signed tables, the counter-and-receipt discipline of Algorithm 3—and not of any abstract preference about how much to trust a delegate.

The distinctions from conventional categories are made explicit. Relative to zero-trust architectures, which re-authenticate and re-authorize every request against a policy engine, the present arrangement replaces the policy decision itself with a signed, reproducible computation: the question is not whether a request passes policy but what quantity of authority the chain, table, and attested context yield, identically at any verifier. Relative to token-exchange delegation, in which an authorization server narrows scopes at each exchange, narrowing here is enforced in key derivation, so no server exists whose misconfiguration can widen a scope. Relative to public-key-infrastructure certificate chains, which convey identity and binary authorization along a chain, credentials here convey a computed, context-responsive quantity, and chain validity is anchored to hardware counters rather than to revocation lists whose consumption is unprovable. Relative to workload identity frameworks issuing short-lived attestations of workload identity, identity freshness here is an input to the authority computation rather than the authorization itself. Relative to attribute-based access control, in which attributes feed a policy engine whose evaluation is neither signed nor reproducible across verifiers, the context vector feeds a version-hashed table whose result any verifier recomputes exactly.

Exemplary computing environment and computer-readable media. The processes described herein execute on computing devices comprising one or more processors, memory, storage, network interfaces, and the identified hardware security components. Instructions implementing the described operations may be stored on non-transitory computer-readable media—which excludes transitory propagating signals—and executed to cause performance of the operations; relying-party operations described with reference to FIG. 4, FIG. 5, and FIG. 8 may be embodied entirely as such instructions executed by transaction-processing systems, including payment network nodes, that neither operate a delegation authority nor host delegates.

The described system is not an abstract scheme for deciding how much to trust a delegate. It is a specific architecture of secure-element issuance, scope-intersection key derivation (Algorithm 1 bound into the derivation context), deterministic context-weighted attenuation under signed rule tables (Algorithm 2), hardware-authenticated oversight gating, counter-anchored, acknowledgment-receipted cascade revocation (Algorithm 3), and dual-signed deterministic scope translation (Algorithm 4), whose technical effects—constructive impossibility of over-delegation, reproducible graded authority computed at exercise time, and provable revocation propagation—follow from the recited structures and are not obtainable from the token formats or policy conventions of prior authorization infrastructure.

What is claimed is:

1. A system for delegating trust authority to autonomous software agents, the system comprising: a secure element of a principal device configured to sign a root delegation credential specifying at least a scope expression in a deterministic canonical encoding, a quantitative bound, a maximum delegation depth, a reference identifying a signed transitivity rule table by version hash, and a revocation epoch reference; a derivation module executing within a trusted execution environment of an agent computing device and configured to derive a child delegation credential using a key-derivation function whose context input includes a scope bound computed as an intersection of a parent credential's scope and a requested scope and a decremented delegation depth, whereby a child credential asserting a scope exceeding the parent credential's scope corresponds to no derivable key; and a transitivity engine executing within a trusted execution environment and configured to compute, for a requested action of a presenting delegate, an effective authority as a deterministic function of the root credential's bound, per-hop attenuation coefficients retrieved from the transitivity rule table by the version hash, and a context vector assembled at verification time from attested inputs and comprising at least a risk class of the requested action, an attestation freshness of the presenting delegate, and a chain depth, and to emit a signed effective-authority determination binding a credential-chain digest, the context vector, the rule-table version hash, and the computed effective authority, wherein the requested action is authorized only within the effective authority so determined, wherein an independent verifier supplied with the credential-chain digest, the context vector, and the rule-table version hash recomputes an identical effective authority, and wherein computing the effective authority comprises retrieving, for each component of the context vector, an attenuation coefficient designated in the transitivity rule table for an attested value of that component and applying each retrieved coefficient to the root credential's bound.

2. The system of claim 1, wherein the context vector further comprises an evidence recency of the root delegation, and wherein the deterministic function applies a floor value per action class below which effective authority is treated as absent.

3. The system of claim 1, wherein each delegation credential comprises a chain digest field binding the credential to a digest of its parent credential, and wherein the transitivity engine validates chain order by verifying each chain digest against the presented parent before computing effective authority.

4. The system of claim 1, further comprising a revocation service configured to publish signed epoch beacons identifying revoked subtrees of an epoch tree, wherein each relying node advances a hardware monotonic counter upon verified beacon receipt and returns a signed acknowledgment receipt binding the node's identity, a digest of the beacon, and an attestation of the node's counter state, the acknowledgment receipts being recorded in an acknowledgment ledger.

5. The system of claim 4, wherein an authorization, by a relying node, of a credential referencing a superseded epoch after a timestamp of that node's acknowledgment receipt is determinable as noncompliant from the acknowledgment ledger and the node's authorization records.

6. The system of claim 1, wherein at least one delegation credential carries an oversight predicate, and wherein a relying party suspends authorization of an action satisfying the oversight predicate pending an approval signed by a hardware authenticator registered to the principal or to a designated overseer, the approval being bound into an authorization record.

7. The system of claim 1, further comprising a scope-translation gateway executing within an attested environment and configured to translate a delegation credential of a first organization into scope semantics of a second organization by deterministic application of a translation table signed by both organizations and identified by version hash, untranslatable clauses being struck rather than approximated.

8. A method of delegating, exercising, and revoking trust authority, the method comprising: signing, by a secure element of a principal device, a root delegation credential specifying a scope expression in a deterministic canonical encoding, a quantitative bound, a maximum delegation depth, a reference to a signed transitivity rule table, and a revocation epoch reference; deriving, within a trusted execution environment of an agent computing device, a child delegation credential using a key-derivation function whose context input includes a scope bound computed as an intersection of parent scope and requested scope and a decremented depth, derivation being refused when the depth reaches zero; validating, at a relying party, a presented delegation chain including per-link signatures, parent-digest bindings, depth decrements, and scope containment; assembling, at verification time and from attested inputs, a context vector comprising at least a risk class of a requested action, an attestation freshness of the presenting delegate, and a chain depth; computing an effective authority for the requested action as a deterministic function of the root credential's bound, per-hop attenuation coefficients of the transitivity rule table identified by version hash, and the context vector; emitting a signed effective-authority determination; authorizing the requested action only within the determined effective authority; revoking a delegation subtree by publishing a signed epoch beacon identifying the subtree by a constant-size epoch-tree node identifier; advancing a hardware monotonic counter at the relying party upon verified receipt of the epoch beacon; and returning, from the relying party, a signed acknowledgment receipt binding an identity of the relying party, a digest of the epoch beacon, and an attestation of a state of the hardware monotonic counter, the acknowledgment receipt establishing a latest time by which the relying party received the revocation.

9. The method of claim 8, further comprising emitting, upon each authorized exercise of delegated authority, a signed exercise receipt binding the credential-chain digest, the effective-authority determination, and a digest of the action, into an append-only log.

10. The method of claim 8, further comprising recording the acknowledgment receipt in an acknowledgment ledger, and determining, from the acknowledgment ledger and authorization records of the relying party, that an authorization of a credential referencing a superseded epoch after a timestamp of the acknowledgment receipt is noncompliant.

11. The method of claim 8, further comprising applying, at a relying party whose most recently acknowledged beacon exceeds a configured age, a degraded-mode reduction of computed effective authority, according to a degraded-mode coefficient designated in the transitivity rule table, for all delegation chains until a current beacon is acknowledged.

12. The method of claim 8, wherein the scope expression comprises a conjunction of clauses each specifying an action class from a published taxonomy with optional counterparty constraints and quantitative bounds, without negation or recursion, whereby scope containment and scope intersection are decided identically by independent verifiers.

13. The method of claim 8, further comprising suspending authorization of an action satisfying an oversight predicate carried in the delegation chain, pending a human approval signed by a registered hardware authenticator or a threshold number of approvals signed by registered hardware authenticators of a designated overseer set, and binding each approval into the authorization record.

14. The method of claim 8, wherein signatures of at least one of the secure element and derived credential keys are generated under a lattice-based post-quantum signature scheme or under a hybrid of a classical signature scheme and a lattice-based post-quantum signature scheme, and wherein a verifier requires post-quantum or hybrid signatures for a designated risk class according to an algorithm-agility field of the credential and a per-risk-class designation of the transitivity rule table.

15. A non-transitory computer-readable medium storing instructions that, when executed by one or more processors of a relying party, cause the one or more processors to: receive a delegation credential chain presented with a requested action by an autonomous software agent, each credential of the chain binding a scope expression in a deterministic canonical encoding, a delegation depth, a parent-credential digest, and a revocation epoch reference; validate each link's signature, parent-digest binding, depth decrement, and scope containment; confirm currency of each credential's revocation epoch against both a latest signed epoch beacon and a hardware monotonic counter of the relying party advanced upon verified beacon receipt; assemble, at verification time and from attested inputs, a context vector comprising at least a risk class of the requested action, an attestation freshness of the presenting agent, and a chain depth; compute an effective authority for the requested action as a deterministic function of a root bound of the chain, per-hop attenuation coefficients of a transitivity rule table identified by version hash, and the context vector; and authorize the requested action only within the computed effective authority, emitting a signed determination binding the chain digest, context vector, table version, and computed authority, wherein an independent verifier supplied with the chain digest, the context vector, and the version hash recomputes an identical effective authority, and wherein computing the effective authority comprises retrieving, for each component of the context vector, an attenuation coefficient designated in the transitivity rule table for an attested value of that component and applying each retrieved coefficient to the root credential's bound.

16. The non-transitory computer-readable medium of claim 15, wherein the instructions further cause the one or more processors to return, upon verified receipt of an epoch beacon, a signed acknowledgment receipt binding the relying party's identity, a digest of the beacon, and an attestation of the hardware monotonic counter state.

17. The non-transitory computer-readable medium of claim 15, wherein the instructions further cause the one or more processors to suspend authorization of an action satisfying an oversight predicate carried in the chain pending verification of a human approval signed by a registered hardware authenticator.

18. The non-transitory computer-readable medium of claim 15, wherein the instructions further cause the one or more processors to cache a validated chain prefix keyed to the current epoch and to invalidate the cached prefix upon receipt of a newer signed epoch beacon.

19. The non-transitory computer-readable medium of claim 15, wherein the instructions further cause the one or more processors to apply, when a most recently acknowledged epoch beacon is older than a configured age, a degraded-mode reduction of computed effective authority according to a degraded-mode coefficient designated in the transitivity rule table.

20. The non-transitory computer-readable medium of claim 15, wherein the relying party comprises a payment network node and the authorized action comprises a payment, whereby an agent-initiated payment does not clear in excess of the computed effective authority of the presenting delegation hop.

21. The system of claim 1, wherein the effective authority is computed without appending any caveat or restriction to any credential of the presented chain, each credential of the chain remaining unmodified from its derivation through the emission of the effective-authority determination.

22. The system of claim 1, wherein the transitivity rule table is signed by a hardware security module of a delegation authority, and wherein a change from one rule-table version to another takes effect only at an epoch boundary announced by a signed epoch beacon, whereby the rule-table version governing any determination is decidable from an epoch reference of the presented chain and a sequence of signed epoch beacons.

23. The system of claim 4, wherein the acknowledgment ledger is append-only and hash-chained, with ledger heads periodically countersigned by a hardware security module, whereby omission or reordering of a recorded acknowledgment receipt is detectable from a structure of the acknowledgment ledger.

24. The system of claim 1, wherein the context vector further comprises at least one of a model provenance hash of the presenting delegate, a tool schema integrity digest, an environmental risk signal, and a behavioral reputation score carried as a signed assertion, each entering the deterministic function only through a coefficient of the transitivity rule table.

25. The system of claim 1, wherein the secure element comprises one of a hardware security key, a secure enclave of a personal computing device, a trusted platform module, and a hardware security module.

26. The system of claim 1, wherein at least one of the trusted execution environments comprises one of a virtual-machine-isolation environment, a realm-based confidential computing environment, a process-isolated enclave environment, a system-partition environment, and a confidential virtual machine of a cloud computing provider whose attestation chains to a hardware root of trust.

27. The system of claim 4, wherein a digest of each epoch beacon and periodic chain heads of the acknowledgment ledger are additionally anchored to a distributed ledger, whereby beacon publication times and receipt recording times are independently verifiable without trusting the revocation service.
